(19) United States
(12) Patent Application Publication
(10) Pub. No.: US 2008/0079329 A1
(43) Pub. Date: Apr. 3, 2008

(54) Motor structure

(75) Inventors: Alex Horng, Kaohsiung City (TW); Tso-Kuo Yin, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/602,200

(22) Filed: Nov. 21, 2006

(30) Foreign Application Priority Data
Sep. 29, 2006 (TW) 095136189

(51) Int. Cl. H02K 5/12; H02K 21/00; H02K 1/12

(52) U.S. Cl. 310/254; 310/207; 310/86

(57) ABSTRACT

The present invention relates to a motor structure, including a rotor, a motor seat, a cover body and a stator structure, wherein the stator structure has a flexible base and parts such as coils, a motor induction driving device and the like are disposed on the flexible base. As such, while assembling the stator structure, the parts such as the coils, the motor induction driving device and the like and the assembling, fixing and aligning processes thereof can be neglected, thereby making the manufacture and assembly of the motor structure simpler and more convenient.

### FIELD OF THE INVENTION

The present invention relates to a motor structure, and more particularly to a practical structure that can be conveniently assembled and manufactured to simplify the manufacture and the manufacturing processes of the motor structure and to augment the production efficacy.

### BACKGROUND OF THE INVENTION

As shown in FIG. 1, the conventional motor structure includes a motor 10 coupled with a spindle 101, a motor seat 11 having a rotor containing cavity 111 therein for accommodating the rotor 10, a support member 112 disposed on a bottom portion of the rotor containing cavity 111 and being a part such as a bearing, a sleeve or the like for supporting one end of the spindle 101 of the rotor 10 to centrally rotate therein, a cover body 12 disposed on the top side of the motor seat 11 in a corresponding manner and having a support member 121 provided at a center of the cover body 12 for supporting the other end of the spindle 101 to rotate within a part such as a bearing, a sleeve or the like.

Moreover, even number sets of fixing members 113 disposed respectively on the outer periphery of the motor seat 11 and being symmetrical in a radial direction are used to fix a coil 13 for forming a stator, and a motor induction driving device 14 is further disposed on the outer wall surface of the motor seat 11, thereby forming magnetic induction between the coil 13 and the rotor 10 to drive the rotor 10 for rotation.

Whereas, the stator of the aforementioned motor structure that employs even number sets of coils to be fixed on the outer wall surface of the motor seat 11 and thus gives rise to the following disadvantages;

(1) inconvenient manufacture and assembly—As the stator of the conventional motor structure is formed by fastening even number sets of coils 13 on the outer wall surface of the motor seat 11 respectively, even number sets of coils shall be prepared first and fixed on the outer wall surface of the motor seat 11 respectively. The process for fixing the coils shall be repeated twice, if the number of the coils is two sets, and shall be repeated quadruple if the number of the coils is four sets, not only adding a couple of more production processes but also causing inconvenience in assembly.

(2) easy disengagement of coils—The coils of the conventional motor structure are fixed on the outer wall surface of the motor seat 11 and are attached by engagement with the fixing members 113; if the coils are subjected to the vibration amplitude resulting from rotation of the rotor 10 for long duration, they get disengaged easily.

(3) alignment difficulty—As the even number sets of coils 13 of the conventional motor structure and the motor induction driving element 14 are individually fixed on the outer wall surface of the motor seat 11, while assembling, special attention shall be paid to if precise alignment between those members is necessary; otherwise, the motor is hard to start up.

Therefore, to completely tackle the issue existing in the aforementioned conventional motor structure, a motor structure with a brand new idea shall be aggressively conceived and developed so as to simplify the manufacture of the motor structure and the assembling process, to reduce the production cost and to augment the production efficacy.

### SUMMARY OF THE INVENTION

In view of the foregoing concern, the present invention thus provides a motor structure, including a rotor, a motor seat, a cover body and a stator structure, wherein the stator structure has a flexible base having coils and a motor induction driving device, and the coils and the motor induction driving device are electrically connected.

Because the coils, the parts of the stator structure such as the motor induction driving device, etc. in the present invention are disposed on the flexible base beforehand. Hence, those parts can be neglected while assembling the stator structure, and each respective assembling, fixing or aligning process makes the assembly and manufacture simpler and easier, thereby not only reducing defective rate of the product but also lowering the production cost.

### BRIEF DESCRIPTION OF THE DRAWINGS

FIG. 1 is a 3D exploded view showing a conventional structure;

FIG. 2 is a 3D exploded view showing a first preferred embodiment of the present invention;

FIG. 3 is cross sectional view showing an assembly of the first preferred embodiment of the present invention;

FIG. 4 is a cross sectional view showing the assembly of the first preferred embodiment;

FIG. 5 is a 3D exploded view showing a second preferred embodiment of the present invention;

FIG. 6 is a cross sectional view showing an assembly of the second preferred embodiment of the present invention; and

FIG. 7 is a cross sectional view showing the second preferred embodiment.

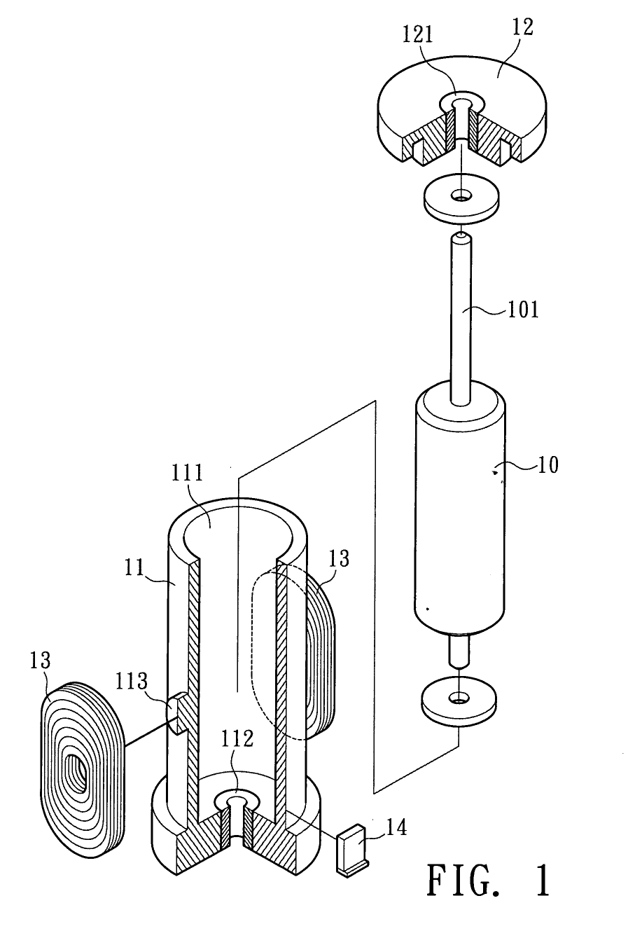

### DETAILED DESCRIPTION OF THE PREFERRED EMBODIMENT

The present invention relates to a motor structure having coils, a motor induction driving device and so forth on a flexible base. Therefore, the respective assembling, fixing and aligning processes for the coils and the motor induction driving device while assembling a stator structure can be neglected, such that the manufacture and assembly of the motor structure become simpler and more convenient.

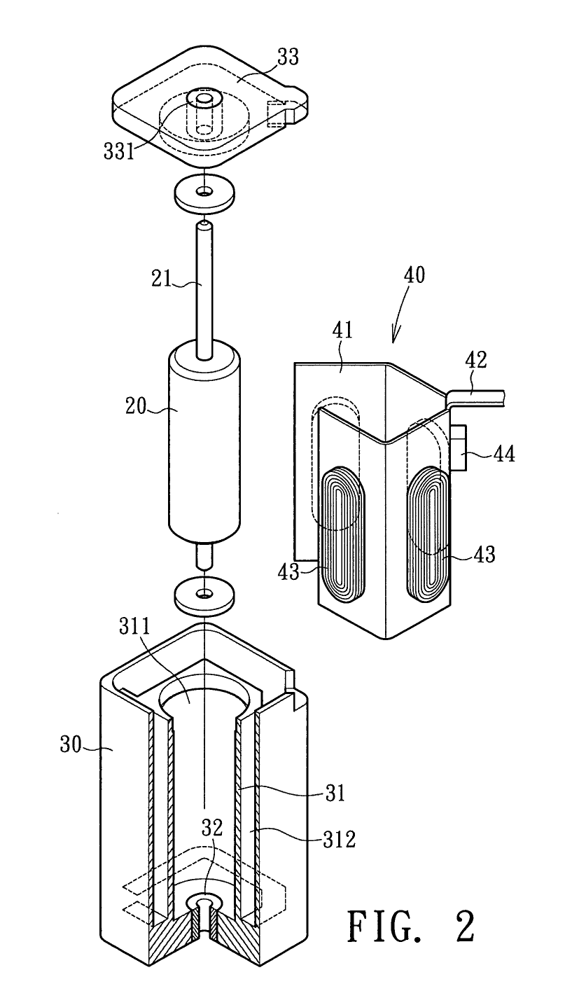

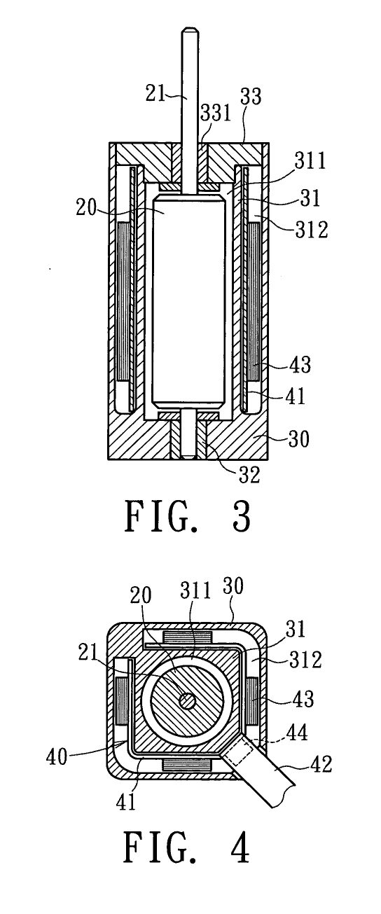

Illustrated below are two preferred embodiments for the present invention. As shown in FIG. 2, FIG. 3 and FIG. 4 illustrative of a first preferred embodiment, a motor structure includes a rotor 20 bundled with a spindle 21; a motor seat 30 being hollow inside and having an surrounded wall 31 so as to form a rotor containing cavity 311 therein and a stator containing slot 312 provided around a periphery of the surrounded wall 31, wherein the rotor containing cavity 311 is for accommodating the rotor 20 therein, a support member 32 is disposed on the bottom part of the rotor containing cavity 311, the support member 32 can be a part such as a bearing, a sleeve or the like for supporting one end of the spindle of the rotor 20 to rotate therein; a cover body 33 disposed on a top side of the motor seat 31 and having a support member 331 disposed therein, wherein the support member 331 can be a part such as a bearing, a sleeve or the like similarly for supporting the other end of the spindle 21 to rotate therein; a stator structure 40 having a flat cable 42 extended from a flexible base 41, and the included angle formed between the flat cable 42 and the flexible base 41 is smaller than 180°.

Beside, the flexible base has coils 43 and a motor induction driving device 44. The number of coils 43 can be configured to be more than one (four configured as illustrated). If the number of coils 43 is more than two, the distance between every two neighboring coils is arranged to be the same on the flexible base 41, and each coil 43 and the motor induction driving device 44 shall be electrically connected to generate an alternating magnetic field.

As illustrated by FIG. 3 and FIG. 4, the flexible base 41 of the stator structure 40 can coincide with the stator containing slot 312 in any form, such as a square as shown in FIG. 4, for being bent and inserted in the stator containing slot 312 to surround the surrounded wall 31, such that motor induction is generated between the coils 43 or the motor induction driving device 44 and the rotor 20 inside the rotor containing cavity 311 to drive the rotor 20 for rotation.

The parts such as the coils 43, the motor induction driving device 44 and the like of the stator structure 40 of the present invention are arranged and fixed on a flexible base 41 beforehand. As a result, while assembling the stator structure 40, the aligning and assembling processes of the coils 43 and the motor induction driving device 44 can be neglected to make the manufacture of the motor structure simpler and more convenient.

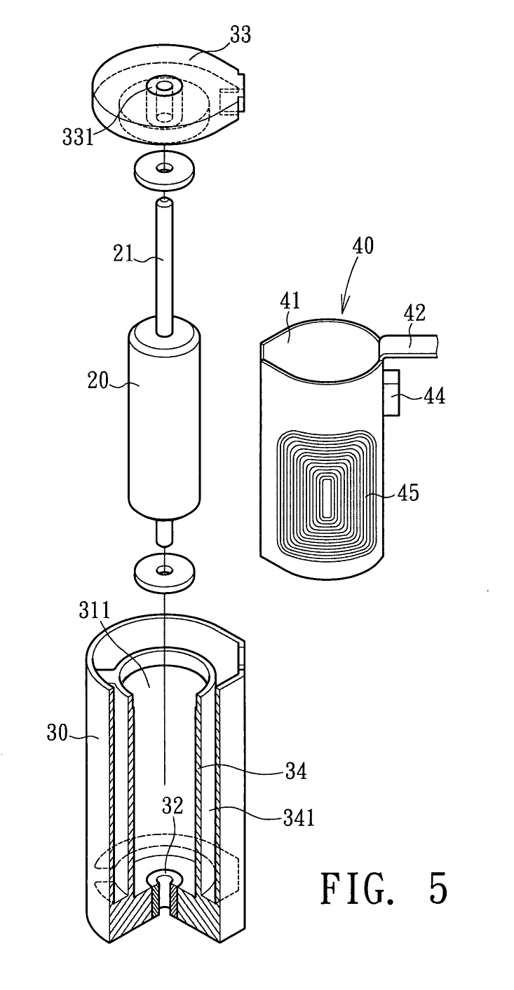

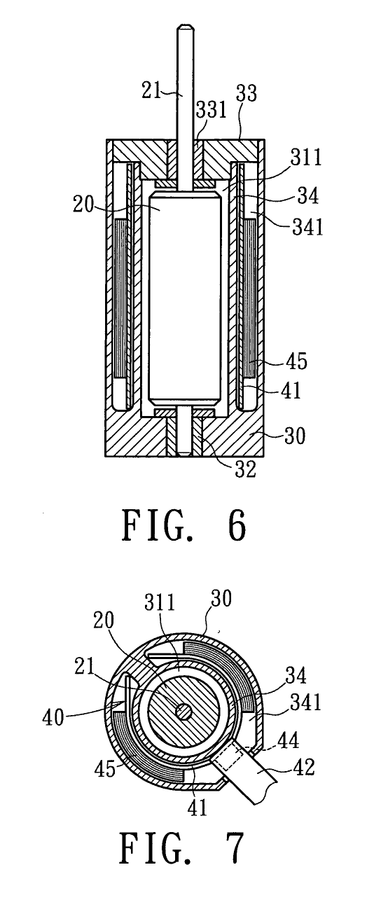

Illustrated in FIG. 5, FIG. 6 and FIG. 7 are the second preferred embodiment of the present invention; similarly, the preferred embodiment is composed of a rotor 20, a motor seat 30 and a stator structure 40.

As shown in FIG. 6 and FIG. 7, the surrounded wall 34 of the motor seat 30 and the stator containing slot 341 are all circular in shape.

Likewise, coils 45 are provided on the flexible base 41 of the stator structure 40. Whereas, the number of the coils is arranged to be two, and the two coils 45 are pre-modeled roughly in form of arc. Consequently, when the flexible base 41 is bent and inserted in the stator containing slot 341, the two coils 45 can be adhered to the periphery of the surrounded wall 34, thereby reducing space consumption of the motor seat 30 on the one hand while augmenting magnetic induction sensitivity between the coils 45 and the rotor 20.

When comparing the motor stator structure of the present invention with the aforementioned conventional structure, the characteristics of the present invention at least includes:

(1) convenient manufacture and assembly—The coils, the motor induction driving device, etc. of the stator structure in the present invention are disposed on a flexible base. Hence, when assembling the stator structure, the mounting and the positioning processes of each coil can be saved, thereby making the manufacture of the motor structure simpler and more convenient.

(2) No disengagement concern of coil—The parts such as the flexible base, the coils and the motor induction driving device of the stator structure are bent and inserted in the stator containing slot of the motor seat and then is fixed with the cover body, thereby making the entire stator structure free of disengagement concern by encasing and protecting the entire stator structure with the motor seat.

(3) No alignment issue—The parts of the coils and the motor induction driving device of the stator structure in the present invention are disposed at predetermined positions on a flexible base, and the flexible base is just placed in the stator containing slot without requiring specific alignment.

In sum, from the above-mentioned characteristics those features not only has a novelty among similar products and a progressiveness, but also has an industry utility

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A motor structure, comprising:
a motor seat having an surrounded wall disposed therein, a rotor containing cavity centrally provided inside said surrounded wall for accommodating a rotor, and a stator containing slot disposed around said surrounded wall; and
a stator structure having a flexible base bent and modeled in accordance with a form of said stator containing slot and inserted therein, a plurality of coils, and a motor induction driving device electrically connected with said plural coils.

2. The motor structure of claim 1, wherein a flat cable is extended from said flexible base and forms an included angle being equal to or less than 180 degrees with said flexible base.

3. The motor structure of claim 1, wherein a cross sectional form of said stator containing slot is square-like.

4. The motor structure of claim 1, wherein a cross sectional form of said stator containing slot is disc-like.

5. The motor structure of claim 4, wherein said coils of said stator structure are pre-modeled in a form of an arc and fully attached to said outer periphery of said surrounded wall.
